(19) United States
(12) Patent Application Publication
(10) Pub. No.: US 2025/0282114 A1
(43) Pub. Date: Sep. 11, 2025

(54) PRESSING TOOL AND PRESSING METHOD

(71) Applicant: OPTIMA life science GmbH, Schwäbisch Hall (DE)

(72) Inventors: Michael Joos, Schwäbisch Hall (DE); Michael Lutz, Schwäbisch Hall (DE)

(73) Assignee: OPTIMA life science GmbH, Schwäbisch Hall (DE)

(21) Appl. No.: 19/071,561

(22) Filed: Mar. 5, 2025

(30) Foreign Application Priority Data
Mar. 5, 2024 (DE) 102024106265.7

(51) Int. Cl. B30B 1/26; B30B 15/02; B30B 15/06

(52) U.S. Cl. CPC B30B 1/266; B30B 15/026; B30B 15/064

(57) ABSTRACT

The invention relates to a pressing tool and a method for pressing a single- or multi-layer product in a web-processing operation by means of a pressing tool (1) comprising a frame (3), an upper tool module (4) with an upper pressing plate (40) and a lower tool module (5) with a lower pressing plate (50), the upper tool module (4) and the lower tool module (5) each being adjustably mounted on the frame in the transport direction (I) of the web-processing operation, wherein, after the pressing tool (1) has been closed, the upper tool module (4) and the lower tool module (5) are driven separately relative to the frame (3) in a synchronous manner in the transport direction (I) during an operating period.

### CROSS-REFERENCE TO RELATED APPLICATION

The present application claims priority to German Patent Application No. 102024106265.7, filed Mar. 5, 2024, the entirety of which is incorporated herein by reference.

### FIELD OF APPLICATION AND PRIOR ART

The invention relates to a pressing tool and a method for pressing a single- or multi-layer product in a web-processing operation.

In the context of the registration, processes in which material webs are processed are referred to as web-processing operations.

Web-processing operations are used in particular for the processing or production of multilayer products, also known as laminates or stacks. It is known to provide starting materials for the layers of the multilayer product in the form of a material web in each case, with two or more material webs being contacted with each other between two rollers and then joined by means of pressing. In addition, it is known to deposit blanks on material webs for individual or all layers of the product for transportation, the blanks being joined to the material web and/or to another blank deposited on the material web by means of pressing.

Stacks or laminates are known for a wide range of applications, for example for wound dressings, for hygiene products, for textile products, and for fuel cells or batteries and other products. In particular, for fuel cells, redox-flow batteries, and other applications, it is known to produce stacks or laminates comprising a usually very sensitive membrane in a web-processing operation.

For pressing a single- or multi-layer product, heated pressing tools, also known as hot presses or heating presses, are known in which heat is transferred to the supplied products. Heat is used to shape the product and/or to bond two or more layers of a multi-layer product. Joining the layers of a multi-layer product by means of heat is also referred to as sealing.

Known pressing tools comprise a frame and two pressing plates arranged in the frame, with a single- or multi-layer product or a product group being placed between the pressing plates for pressing. At least one first pressing plate is assigned a drive by means of which the first pressing plate can be adjusted in the direction of the second pressing plate to apply a force.

In a web-processing operation, it is known to feed a section of a material web with a product or a product group into the pressing tool. For continuous or intermittent movement of the pressing tool with the material web during pressing, it is known to move the frame, including the pressing plates arranged thereon, during a processing period in the transport direction of the material web, by means of a drive, synchronously with the latter. When the processing time has elapsed, the first pressing plate is moved away from the second pressing plate to open the pressing tool. The frame then moves back and is then synchronized to the next product or product group.

The size of the pressing plates depends on the surface area of the product or product group to be pressed. As the size of the products that are to be manufactured or processed in web-processing operations increases, so does the size of the pressing plates and thus their mass. The frame must also be adjusted to the higher forces.

As a result, drives for a lifting movement of the pressing plates and an adjusting movement of the frame must be dimensioned correspondingly stronger. This results in higher energy costs and/or restrictions in the size of the products and/or in the throughput of the pressing tool.

### Problem and Solution

The invention involves a pressing tool and a method for pressing a single- or multi-layer product in a web-processing operation, which allows the processing of large-area products and/or product groups with several products at relatively low energy costs.

These tasks are solved by the pressing tool and the method with the features of claims 1 and 7. Advantageous designs are shown in the sub-claims.

According to the first aspect, a pressing tool is created for pressing a single- or multi-layer product in a web-processing operation with a transport direction. The pressing tool comprises a frame, an upper tool module with an upper pressing plate, a lower tool module with a lower pressing plate, a control device, a first drive and a second drive, wherein a first guide is provided on the frame, wherein the upper tool module is adjustably connected to the frame in the transport direction by means of the first guide, wherein the first drive is assigned to the upper tool module, the first drive being used to adjust the upper tool module relative to the frame in the transport direction during pressing, a second guide being provided on the frame, the second guide being used to adjust the connection between the lower tool module and the frame in the transport direction, the second drive being assigned to the lower tool module, the second drive being used to adjust the lower tool module in the transport direction relative to the frame during pressing, and the control device being used to couple the first drive and the second drive in terms of control so that the upper tool module and the lower tool module can be adjusted synchronously in the transport direction during pressing.

During pressing, only the mold modules are moved, not the frame. The frame is stationary. Due to the stationary frame, the mass moved during pressing is reduced compared to conventional pressing tools, in which the frame is moved, so that a low drive power is required for movement. The pressing plates can be moved with little energy input compared to conventional pressing tools. Alternatively or additionally, higher process speeds and/or larger press surfaces can be realized.

The first guide and the second guide comprise two parallel guide elements, for example guide rails, along which the upper tool module and the lower tool module can each be guided with a high degree of accuracy.

The terms “a,” “an,” and “one” are used as indefinite articles and not as counting words in the context of the application. In particular, the upper tool module and/or the lower tool module can comprise more than one pressing plate in the design of the pressing tool, with the pressing plates being used to press one or more products of a product group. Likewise, a pressing tool is provided in designs, wherein a product group comprising several products is pressed simultaneously with a pair of pressing plates.

The terms “first,” “second,” etc. are used only for differentiation and do not indicate any order. The terms “upper” and “lower” indicate a relative arrangement of individual components during normal use of the pressing tool. However, there are conceivable uses in which the components are arranged differently relative to one another.

In one embodiment, at least part of the first drive is arranged on the upper tool module and/or at least part of the second drive is arranged on the lower tool module, so that the first drive is at least partially adjusted with the upper tool module and the second drive is at least partially adjusted with the lower tool module relative to the frame.

In particular, it is envisaged that the first drive will be designed as a linear motor, with a slider of the first drive being arranged on the upper tool module, and/or that the second drive will be designed as a linear motor, with a slider of the second drive being arranged on the lower tool module. The linear motors also include permanent magnets arranged on the guides. Long travel distances at high acceleration rates, thrusts, and positioning accuracies are possible using linear motors.

In one design, the upper pressing plate and/or the lower pressing plate can be adjusted by means of a sliding guide to close and open the pressing tool. The mold modules return to their initial position after pressing in such a way that the pressing tool remains open.

In other embodiments, the upper tool module and/or the lower tool module comprise a lifting drive, wherein the upper pressing plate or the lower pressing plate can be adjusted by means of the lifting drive to close and open the pressing tool. The lifting drive allows the pressing tool to be opened and closed quickly. The position for opening and closing the pressing tool along the transport direction is variable and can be individually set for each product or product group.

In embodiments, it is envisaged that the upper tool module and/or the lower tool module will include a heating device, wherein the upper pressing plate or the lower pressing plate can be heated by means of the heating device. The heating device is used to apply heat to shape the product and/or to bond two or more layers of a multi-layer product.

One design provides for the upper pressing plate being replaceably attached to the upper tool module and/or a contour tool being replaceably attached to the upper pressing plate. Alternatively or additionally, it is provided in embodiments that the lower pressing plate is replaceably attached to the lower tool module and/or a contour tool is replaceably attached to the lower pressing plate. In the context of the application, “replaceably attached” refers to an attachment that allows the pressing plate(s) and/or the contour tools attached to them to be removed and replaced with other pressing plate(s) and/or other contour tools in the event of wear or to adapt them to a process. Interchangeable contour tools mounted on the pressing plates are particularly advantageous when format changes are frequent.

According to a second aspect, a method for pressing a single- or multi-layer product in a web-processing operation by means of a pressing tool comprising a frame, an upper tool module with an upper pressing plate and a lower tool module with a lower pressing plate, the upper tool module and the lower tool module each being adjustably mounted on the frame in the transport direction of the web-processing operation, characterized in that, after closing the pressing tool, the upper tool module and the lower tool module are driven separately for a synchronous movement in the transport direction relative to the frame during an operating period.

The upper and lower tool modules are driven in configurations by means of a central system control. The tool modules are each individually synchronized in configurations, for example, by a position and/or movement of a product. In other configurations, the tool modules are driven hierarchically, with one tool module following the movement of the other tool module.

One design provides for the upper and lower tool modules to be synchronized with the product to be pressed before the pressing tool is closed. If several products are processed simultaneously using the pressing tool, a synchronization is carried out in a design for a defined product of the product group. In other versions, several product pairs are provided for simultaneous pressing, with each pair of pressing plates being synchronized to one product.

One design also envisages opening the pressing tool at the end of the operating period and synchronizing the upper tool module and the lower tool module with a subsequent product. If several products are fed to the pressing tool module at the same time, the above applies analogously. During a movement after opening and before closing the pressing tool, synchronization is eliminated in the design and/or a tolerance for synchronization is increased compared to a movement after closing and before opening the pressing tool.

In one design, the upper tool module and/or the lower tool module is/are heated by means of a heating device, so that heat is applied to the product(s) during pressing.

### BRIEF DESCRIPTION OF THE DRAWINGS

Further advantages and aspects of the invention arise from the claims and from the description of exemplary embodiments of the invention, which are explained below on the basis of a FIGURE. This shows:

FIG. 1 schematically shows an exemplary embodiment of a pressing tool.

### DETAILED DESCRIPTION OF THE EXEMPLARY EMBODIMENTS

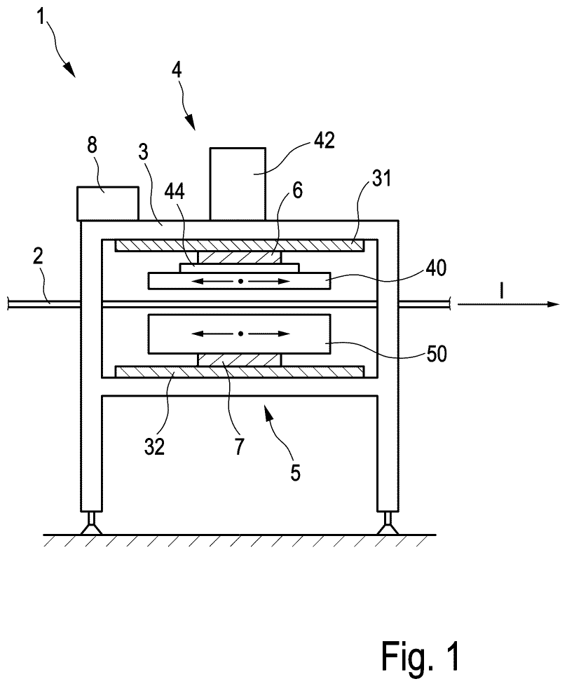

FIG. 1 schematically shows a pressing tool 1 for pressing a single- or multi-layer product or a product group comprising several single- or multi-layer products in a web-processing operation. The product or products are regions of a single- or multi-layer material web 2 and/or blanks deposited on the material web 2. The material web 2 is moved continuously or intermittently in a transport direction I indicated by an arrow for the purpose of manufacturing or processing the products, with a section of the material web 2 comprising a product or a product group being fed to the pressing tool 1 in each case.

The pressing tool 1 comprises a frame 3, an upper tool module 4 with an upper pressing plate 40, and a lower tool module 5 with a lower pressing plate 50. In the illustrated exemplary embodiment, the upper tool module 4 comprises a lifting drive 42. By means of the lifting drive 42, the upper pressing plate 40 of the pressing tool 1 can be adjusted in the direction of the lower pressing plate 50 to close it and away from the lower pressing plate 50 to open the pressing tool 1. In other embodiments, both tool modules 4, 5 have a lifting drive or a lifting drive is only provided on the lower tool module 5 for opening and closing the pressing tool 1.

In the illustrated exemplary embodiment, the upper pressing plate 40 can be heated by means of a heating device 44 shown in schematic form. The upper pressing plate 40 is also referred to as the sealing head and the lower pressing plate 50 as the sealing table.

The frame 3 is stationary. A first guide 31 and a second guide 32 are provided on the frame 3. The upper tool module 4 is connected to the frame 3 by means of the first guide 31 so that it can be adjusted in the transport direction I, so that the upper tool module 4 can be moved synchronously with the material web 2 in the transport direction I during pressing. The lower tool module 5 is connected to the frame 3 by means of the second guide 32 so that it can be adjusted in the transport direction I, while the lower tool module 4 can be moved relative to the frame 3 in synchronism with the material web 2 in the transport direction I during a pressing operation.

Two separate drives 6, 7 are provided for adjusting movements of the upper tool module 4 and the lower tool module 5. The two separate drives 6, 7 are coupled by means of a schematically represented control device 8, so that a synchronous movement of the upper tool module 4 and the lower tool module 5 takes place.

The separate but synchronous movement of the upper tool module 4 and the lower tool module 5 by means of the drives coupled by the control device is also referred to as a “two-phase” movement.

The control device 8 is only shown schematically. In some configurations, the control device 8 comprises several units that are arranged on the frame 3, the upper tool module 4, and/or the lower tool module 5.

A coupling of the drives 6, 7 by means of the control device is hierarchically designed in configurations, with one of the drives 6, 7 being controlled as the primary drive. The primary drive tracks the other drive as a secondary drive so that the two drives are operated synchronously. In other embodiments, a central control system is provided which specifies a target movement to which both drives 6, 7 are synchronized. The central control system is part of a central plant control system in some configurations.

The drives 6, 7 for an adjusting movement of the tool modules 4, 5 are arranged in configurations at least partially stationary on the frame 3. In other configurations, the drives 6, 7 are arranged on the tool modules 4, 5 and are moved with the tool modules 4, 5. In their design, the drives 6, 7 are linear motors comprising permanent magnets arranged on the frame 3, more precisely on the guides 31, 32, as a stator, and electromagnets arranged on the respective tool modules 4, 5 as sliders.

In operation, a section of material web 2 is fed into the pressing tool 1. The upper tool module 3 and the lower tool module 4 are synchronized to form a product and/or a product group and the pressing tool is closed. The upper tool module 3 and the lower tool module 4 are moved relative to the frame synchronously with the material web 2 for an operating period. Then the pressing tool 1 opens and the tool modules 3, 4 are moved back in the opposite direction of transport to a starting position and synchronized with a subsequent product or a subsequent product group.

In the illustrated exemplary embodiment, the upper tool module 4 and the lower tool module 5 each comprise exactly one pressing plate 40, 50. In other embodiments, the upper tool module 4 and the lower tool module 5 each comprise several pressing plates 40, 50. In this case, a drive is provided for each pressing plate, by means of which the pressing plates can be adjusted both synchronously for a pressing process and relative to one another to adjust the distance between individual products in a product group.

1. A pressing tool for pressing a single- or multi-layer product in a web-processing operation with a transport direction, the pressing tool comprising a frame, an upper tool module with an upper pressing plate, a lower tool module with a lower pressing plate and a control device, wherein a first guide is provided on the frame, the upper tool module being connected to the frame such that it can be adjusted in the transport direction by means of the first guide, a first drive being assigned to the upper tool module, the upper tool module being adjustable relative to the frame in the conveying direction by means of the first drive during pressing, and in that a second guide is provided on the frame, the lower tool module being adjustably connected to the frame in the conveying direction by means of the second guide, the lower tool module being assigned a second drive, it being possible for the lower tool module to be adjusted relative to the frame in the transport direction by means of the second drive during pressing, and the first drive and the second drive being coupled in terms of control by means of the control device so that the upper tool module and the lower tool module can be adjusted synchronously in the transport direction during pressing.

2. The pressing tool according to claim 1, wherein at least part of the first drive is arranged on the upper tool module and/or in that at least part of the second drive is arranged on the lower tool module.

3. The pressing tool according to claim 2, wherein the first drive is designed as a linear motor, a slider of the first drive being arranged on the upper tool module, and/or in that the second drive is designed as a linear motor, a slider of the second drive being arranged on the lower tool module.

4. The pressing tool according to claim 1, wherein the upper tool module comprises a lifting drive and/or the lower tool module comprises a lifting drive, wherein the upper pressing plate and/or the lower pressing plate can be adjusted by means of the lifting drive in order to close and open the pressing tool.

5. The pressing tool according to claim 1, wherein the upper tool module comprises a heating device and/or the lower tool module comprises a heating device, wherein the upper pressing plate and/or the lower pressing plate can be heated by means of the heating device.

6. The pressing tool according to claim 1, wherein the upper pressing plate is replaceably attached to the upper tool module and/or a contour tool is replaceably attached to the upper pressing plate, and/or in that the lower pressing plate is replaceably attached to the lower tool module and/or a contour tool is replaceably attached to the lower pressing plate.

7. A method for pressing a single- or multi-layer product in a web-processing operation by means of a pressing tool comprising a frame, an upper tool module with an upper pressing plate and a lower tool module with a lower pressing plate, the upper tool module and the lower tool module each being adjustably mounted on the frame in the transport direction of the web-processing operation, wherein after the pressing tool has been closed, the upper tool module and the lower tool module are driven separately for a synchronous movement in the transport direction relative to the frame during an operating period.

8. The method according to claim 7, wherein, before the pressing tool is closed, the upper tool module and the lower tool module are synchronized with the product to be pressed.

9. The method according to claim 7, wherein after the operating time has elapsed, the pressing tool is opened and the upper tool module and the lower tool module are synchronized to a subsequent product.

10. The method according to claim 7, wherein the upper tool module and/or the lower tool module is/are heated by means of a heating device.
